(19) United States
(12) Patent Application Publication
(10) Pub. No.: US 2026/0163097 A1
(43) Pub. Date: Jun. 11, 2026

(54) BATTERY CELL COOLING

(71) Applicant: GM Global Technology Operations LLC, Detroit, MI (US)

(72) Inventors: Zhenwen Hu, Shanghai (CN); Oliver Rene Rudwinsky, Oakland, MI (US); Alexander M. Bilinski, Avoca, MI (US); Jian Yao, Shanghai (CN); Chengwu Duan, Shanghai (CN); Zhen Gao, Shanghai (CN)

(21) Appl. No.: 18/982,756

(22) Filed: Dec. 16, 2024

(30) Foreign Application Priority Data
Dec. 5, 2024 (CN) 202411785887.X

(51) Int. Cl. H01M 10/613; H01M 10/625; H01M 10/6552; H01M 50/249

(52) U.S. Cl. CPC H01M 10/613; H01M 10/625; H01M 10/6552; H01M 50/249

(57) ABSTRACT

A cooling system for a rechargeable battery pack includes a plurality of thermal cooling channels adapted to be positioned between adjacent rows of individual battery cells of the battery pack, an inlet flow channel in fluid communication with each one of the plurality of thermal cooling channels and adapted to connect to a supply of coolant and provide a flow path between the supply of coolant and each one of the plurality of thermal cooling channels, and an exit flow channel in fluid communication with each one of the plurality of thermal cooling channels and adapted to provide a flow path for coolant to exit each one of the plurality of thermal cooling channels, the inlet flow channel including at least one U-hose connector adapted to route the inlet flow channel around a structural cross member of the battery pack.

### INTRODUCTION

The present disclosure relates to a battery cell cooling system within a rechargeable battery pack of an electric vehicle having channels adapted to provide a supply of cooling fluid to and from thermal cooling channels.

More specifically, aspects of this disclosure relate to multi-function, integrated structural support beams with internal cooling channels and tunable transverse elastic compliance, and further including protection against thermal propagation events. Thermal propagation refers to a situation where the temperature of one battery cell increases rapidly and causes the temperature of an adjacent battery cell to also increase rapidly. Rigid cross beams are used for structural integrity. Separate cooling channels are used to provide a flow of cooling fluid through the battery pack and absorb heat, cooling the battery pack. These individual components take up space in the battery pack, resulting in a decrease in overall battery pack energy density.

Thus, while current battery packs achieve their intended purpose, there is a need for a new and improved cooling system for a battery pack with efficient routing of coolant between thermal cooling channels within the cooling system.

### SUMMARY

According to several aspects of the present disclosure, a cooling system for a rechargeable battery pack includes a plurality of thermal cooling channels adapted to be positioned between adjacent rows of individual battery cells of the battery pack, an inlet flow channel in fluid communication with each one of the plurality of thermal cooling channels and adapted to connect to a supply of coolant and provide a flow path between the supply of coolant and each one of the plurality of thermal cooling channels, and an exit flow channel in fluid communication with each one of the plurality of thermal cooling channels and adapted to provide a flow path for coolant to exit each one of the plurality of thermal cooling channels, the inlet flow channel including at least one U-hose connector adapted to route the inlet flow channel around a structural cross member of the battery pack.

According to another aspect, the inlet flow channel comprises a plurality of inlet flow channel segments, and wherein, a first inlet flow channel segment includes a distal end having a connection base positioned thereon, the connection base of the distal end of the first inlet flow channel including an upward facing orifice adapted to receive a downward facing first distal end of the at least one U-hose connector, and a second inlet flow channel segment includes a distal end having a connection base positioned thereon, the connection base of the second inlet flow channel including an upward facing orifice adapted to receive a downward facing second distal end of the at least one U-hose connector, and the at least one U-hose connector having a shape extending upward from the connection base of the first inlet flow channel segment, laterally over a structural cross member of the battery pack and downward to the connection base of the second inlet flow channel segment, defining a flow path interconnecting the first inlet flow channel segment to the second inlet flow channel segment.

According to another aspect, the first distal end of the at least one U-hose connector includes a hose fixture mounted thereon and adapted to be secured to the connection base of the first inlet flow channel segment to secure the first distal end of the at least one U-hose connector within the orifice of the connection base of the first inlet flow channel segment, and the second distal end of the at least one U-hose connector includes a hose fixture mounted thereon and adapted to be secured to the connection base of the second inlet flow channel segment to secure the second distal end of the at least one U-hose connector within the orifice of the connection base of the second inlet flow channel segment.

According to another aspect, the flow path defined by the at least one U-hose connector has a cross-sectional area that decreases moving from the first distal end of the at least one U-hose connector to the second distal end of the at least one U-hose connector, wherein, a flow rate of coolant flowing from the first distal end to the second distal end increases.

According to another aspect, the flow path defined by the at least one U-hose connector includes features extending into the flow path at a position closer to the second distal end of the at least one U-hose connector than the first distal end of the U-hose connector, the features adapted to decrease the cross-sectional area of the flow path and to break up air bubbles within the flow of coolant.

According to another aspect, the at least one U-hose connector includes a plurality of small tubes positioned within the flow path, parallel to the flow of coolant within the flow path, adjacent the second distal end of the at least one U-hose connector, the tubes adapted to decrease the cross-sectional area of the flow path and break up air bubbles within the flow of coolant.

According to another aspect, the flow path defined by the at least one U-hose connector includes an inner surface having a coating thereon adapted to reduce friction of the inner surface.

According to another aspect, the flow path defined by the at least one U-hose connector includes at least one of a cross-sectional area that decreases moving from the first distal end of the at least one U-hose connector to the second distal end of the at least one U-hose connector, features extending into the flow path at a position closer to the second distal end of the at least one U-hose connector than the first distal end of the U-hose connector, the features adapted to decrease the cross-sectional area of the flow path and to break up air bubbles within the flow of coolant, a plurality of small tubes positioned therein, parallel to the flow of coolant within the flow path, adjacent the second distal end of the at least one U-hose connector, the tubes adapted to decrease the cross-sectional area of the flow path and break up air bubbles within the flow of coolant, and an inner surface having a coating thereon adapted to reduce friction of the inner surface.

According to another aspect, the exit flow channel comprises a plurality of exit flow channel segments and a main exit channel, and wherein, each exit flow channel segment includes a distal end having a connection base positioned thereon and a vertical connector, the connection base including an upward facing orifice, wherein a downward facing first distal end of the vertical connector is received within the upward facing orifice of the connection base, the main exit channel extending laterally over the plurality of thermal cooling channels and structural cross members of the battery pack and in fluid communication with second distal ends of the vertical connector of each of the plurality of exit flow channel segments, and wherein, coolant flows from the plurality of thermal cooling channels into the plurality of exit flow channel segments and through the vertical connectors of the plurality of exit flow channel segments upward to the main exit channel.

According to another aspect, for each of the plurality of exit flow channel segments, the first distal end of the vertical connector of the exit flow channel segment includes a hose fixture mounted thereon and adapted to be secured to the connection base of the exit flow channel segment to secure the first distal end of the vertical connector within the orifice of the connection base of the exit flow channel segment, and the second distal end of the vertical connector defines one of a T-connection or an L-connection to the main exit channel.

According to another aspect, for each of the plurality of exit flow channel segments, the vertical connector defines a flow path from the connection base of the exit flow channel segment to the main exit channel, and a cross-sectional area of the flow path of the vertical connector is individually calibrated such that a total pressure drop across the vertical connector between the exit flow channel segment and the main exit channel is the same for each of the plurality of exit flow channel segments.

According to another aspect, the vertical connector of each of the plurality of exit flow channel segments includes a selectively variable valve, wherein the cross-sectional area of the flow path of the vertical connector is selectively and independently variable.

According to another aspect, for each of the plurality of exit flow channel segments, the cross-sectional area of the flow path of the vertical connector is individually calibrated based on an empirical correlation of the cross-sectional area of the vertical connectors for each of the exit flow channel segments and a distance of the vertical connector from an inlet port and exit port, wherein the inlet port is adapted to connect the inlet flow channel to an external source of coolant and the exit port is adapted to connect the exit flow channel to the external source of coolant.

According to another aspect, for each of the plurality of exit flow channel segments, the vertical connector defines a flow path from the connection base of the exit flow channel segment to the main exit channel, the flow path including turbulator features adapted to increase turbulence within the flow of coolant through the flow path, and a density of the turbulator features within the flow path of the vertical connector is individually calibrated such that a pressure drop across the vertical connector between the exit flow channel segment and the main exit channel is the same for each of the plurality of exit flow channel segments.

According to several aspects of the present disclosure, a rechargeable battery pack includes a plurality of battery cells, and a cooling system for cooling the battery cells, the cooling system including a plurality of thermal cooling channels adapted to be positioned between adjacent rows of individual battery cells of the battery pack, an inlet flow channel in fluid communication with each one of the plurality of thermal cooling channels and adapted to connect to a supply of coolant and provide a flow path between the supply of coolant and each one of the plurality of thermal cooling channels, and an exit flow channel in fluid communication with each one of the plurality of thermal cooling channels and adapted to provide a flow path for coolant to exit each one of the plurality of thermal cooling channels, the inlet flow channel including a plurality of inlet flow channel segments and at least one U-hose connector adapted to route the inlet flow channel around a structural cross member of the battery pack, wherein, a first inlet flow channel segment includes a distal end having a connection base positioned thereon, the connection base of the distal end of the first inlet flow channel including an upward facing orifice adapted to receive a downward facing first distal end of the at least one U-hose connector, and the first distal end of the at least one U-hose connector includes a hose fixture mounted thereon and adapted to be secured to the connection base of the first inlet flow channel segment to secure the first distal end of the at least one U-hose connector within the orifice of the connection base of the first inlet flow channel segment, and a second inlet flow channel segment includes a distal end having a connection base positioned thereon, the connection base of the second inlet flow channel including an upward facing orifice adapted to receive a downward facing second distal end of the at least one U-hose connector, and the second distal end of the at least one U-hose connector includes a hose fixture mounted thereon and adapted to be secured to the connection base of the second inlet flow channel segment to secure the second distal end of the at least one U-hose connector within the orifice of the connection base of the second inlet flow channel segment, and the at least one U-hose connector having a shape extending upward from the connection base of the first inlet flow channel segment, laterally over a structural cross member of the battery pack and downward to the connection base of the second inlet flow channel segment, defining a flow path interconnecting the first inlet flow channel to the second inlet flow channel.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having a battery pack and cooling system in accordance with an exemplary embodiment of the present disclosure;

FIG. 2 is a schematic view of a battery pack frame enclosure for the battery pack and cooling system in accordance with an exemplary embodiment;

FIG. 3 is a schematic view of the battery pack frame enclosure with the cooling system and a plurality of battery cells placed therein;

FIG. 4 is a schematic perspective view of the cooling system according to an exemplary embodiment of the present disclosure;

FIG. 5A is an enlarged view of a portion of FIG. 4 as indicated by the circled portion of FIG. 4 labelled “FIG. 5A”;

FIG. 5B is a schematic view of the first U-hose connector shown in FIG. 5A, wherein the first U-hose connector is shown dis-assembled from the cooling system;

FIG. 6A is an enlarged view of a portion of FIG. 4 as indicated by the circled portion of FIG. 4 labelled “FIG. 6A”;

FIG. 6B is a schematic view of the second U-hose connector shown in FIG. 6A, wherein the second U-hose connector is shown dis-assembled from the cooling system;

FIG. 7 is a schematic sectional view of the first and second U-hose connectors wherein each of the first and second U-hose connectors have a decreasing cross-sectional area;

FIG. 8 is a schematic sectional view of the first and second U-hose connectors wherein each of the first and second U-hose connectors have features extending into a flow path;

FIG. 9 is a schematic sectional view of the first and second U-hose connectors wherein each of the first and second U-hose connectors includes a plurality to tubes positioned within a flow path therein;

FIG. 10 is a sectional view of the first and second U-hose connectors taken along line 10-10 in FIG. 9;

FIG. 11 is a schematic sectional view of the first and second U-hose connectors wherein an inner surface of each of the first and second U-hose connectors has coating thereon adapted to reduce frictional drag;

FIG. 12 is a schematic exploded view of a first distal end of a first, second and third vertical connector;

FIG. 13 is an enlarged view of a portion of FIG. 4 as indicated by the circled portion of FIG. 4 labelled “FIG. 13”;

FIG. 14A is a sectional view of the flow path of the first vertical connector having a plurality of turbulators therein;

FIG. 14B is a sectional view of the flow path of the second vertical connector having a plurality of turbulators therein, a density of the turbulators less than a density of the turbulators in the first vertical connector; and

FIG. 14C is a sectional view of the flow path of the third vertical connector having no turbulators therein.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and non-vehicle related consumer electronic components.

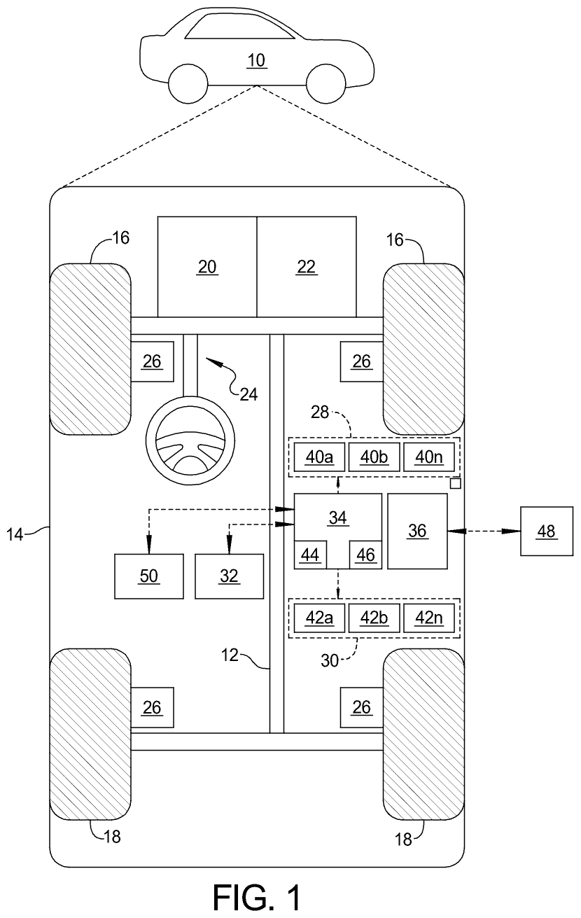

In accordance with an exemplary embodiment of the present disclosure, FIG. 1 shows a vehicle 10 with an associated battery pack 50 having a cooling system 52 in accordance with the present disclosure. In general, the battery pack 50 works in conjunction with other systems within the vehicle 10 to provide power to either or both an electric propulsion system 20 within the vehicle 10 and/or the various systems within the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes an electric propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, the electric propulsion system may include one or more electric motors that are connected to and powered by the battery pack 50, and there may be no transmission system 22. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

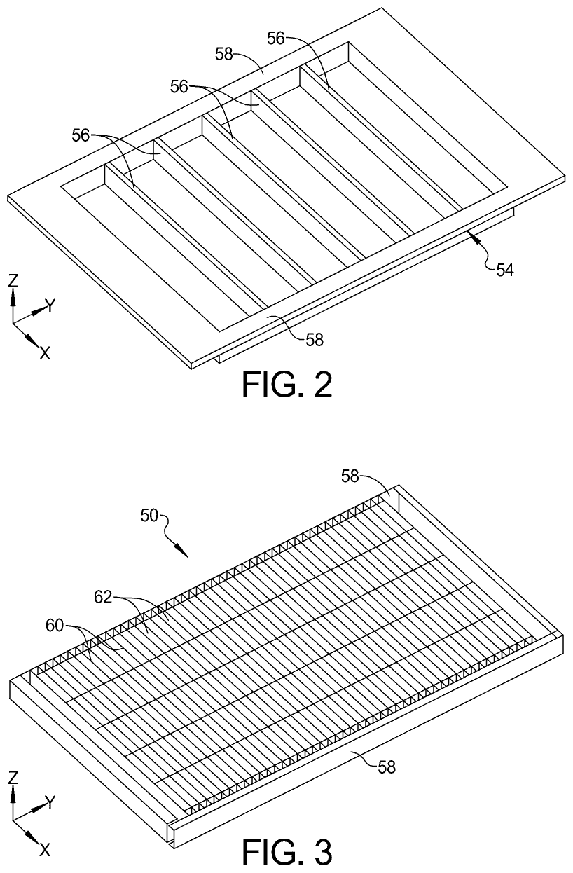

Referring to FIG. 2, a schematic perspective view of an example of a battery pack frame enclosure 54 for the electric vehicle 10 with five structural cross-members 56 that span across the entire width of the battery pack frame enclosure 54 along an X-direction is shown. Two frame enclosure structural side beams 58 run along the length of battery pack frame enclosure 54 in a Y-direction, which protects battery cells 60 of the battery pack 50. Referring to FIG. 3, the battery pack 50 includes a plurality of thermal cooling channels 62, or Super Beam assemblies, located in-between adjacent rows of battery cells 60 and oriented perpendicular to the frame enclosure side beams 58.

Details of the Super Beam assemblies, herein referred to as thermal cooling channels 62, are included in patent application Ser. No. 18/499,726, entitled “Multi-Function Beam with Integrated Structural, Cooling, and Transverse Elastic Compliance Functions For Use with Electric Vehicle Battery Packs” and having a filing/371(c) date of Nov. 1, 2023, the entirety of which is hereby incorporated by reference into the present application.

Referring to FIG. 4, the cooling system 52 is shown wherein the rows of battery cells 60 between the plurality of thermal cooling channels 62 are removed. The cooling system 52 includes an inlet flow channel 64 in fluid communication with each one of the plurality of thermal cooling channels 62 and having a first distal end 80A with an inlet port 66 adapted to connect to a supply of coolant 68 and provide a flow path between the supply of coolant 68 and each one of the plurality of thermal cooling channels 62, as indicated by arrow 70. The cooling system 52 further includes an exit flow channel 72 in fluid communication with each one of the plurality of thermal cooling channels 62 and adapted to provide a flow path for coolant to exit each one of the plurality of thermal cooling channels 62 and return to the supply of coolant 68, as indicated by arrow 74.

The battery pack 50 and cooling system 52 is broken up into modules, wherein each module consists of a portion of the plurality of thermal cooling channels 62, and a portion of the battery cells 60 positioned therebetween, that are positioned between adjacent structural cross-members 56. As shown in FIG. 4, the cooling system 52 includes a first module 76A adjacent a first structural cross-member 56A, a second module 76B between the first structural cross-member 56A and a second structural cross-member 56B, and a third module 76C between the second structural cross-member 56B and a third structural cross-member 56C. The example cooling system 52 shown in FIG. 4 is for illustrative purposes. It should be understood by those skilled in the art that the battery pack 50 and cooling system 52 may include any suitable number of structural cross-members 56 and corresponding modules. To allow the inlet flow channel 64 to extend across the structural cross members 56A, 56B, 56C without having to form a passage through the structural cross members 56A, 56B, 56C, the inlet flow channel 64 includes at least one U-hose connector 78A, 78B adapted to route the inlet flow channel 64 around a structural cross member 56 of the battery pack 50.

In an exemplary embodiment, the inlet flow channel 64 comprises a plurality of inlet flow channel segments 64A, 64B, 64C. A first U-hose connector 78A interconnects a first inlet flow channel segment 64A and a second inlet flow channel segment 64B, and a second U-hose connector 78B interconnects the second inlet flow channel segment 64B to a third inlet flow channel segment 64C.

The interconnection of the first inlet flow channel segment 64A to the second inlet flow channel segment 64B with the first U-hose connector 78A is substantially identical to the interconnection of the second inlet flow channel segment 64B to the third inlet flow channel segment 64C with the second U-hose connector 78B.

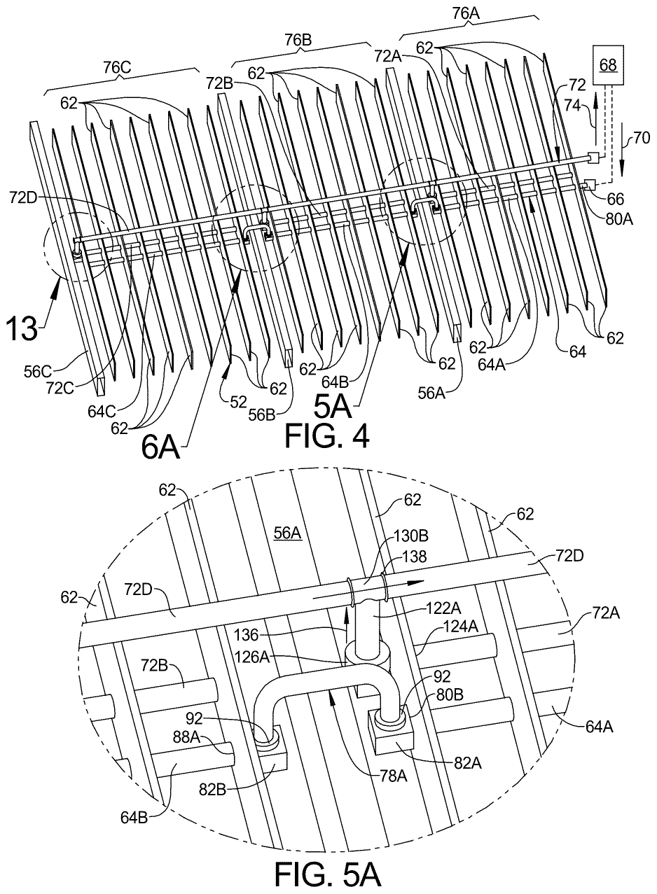

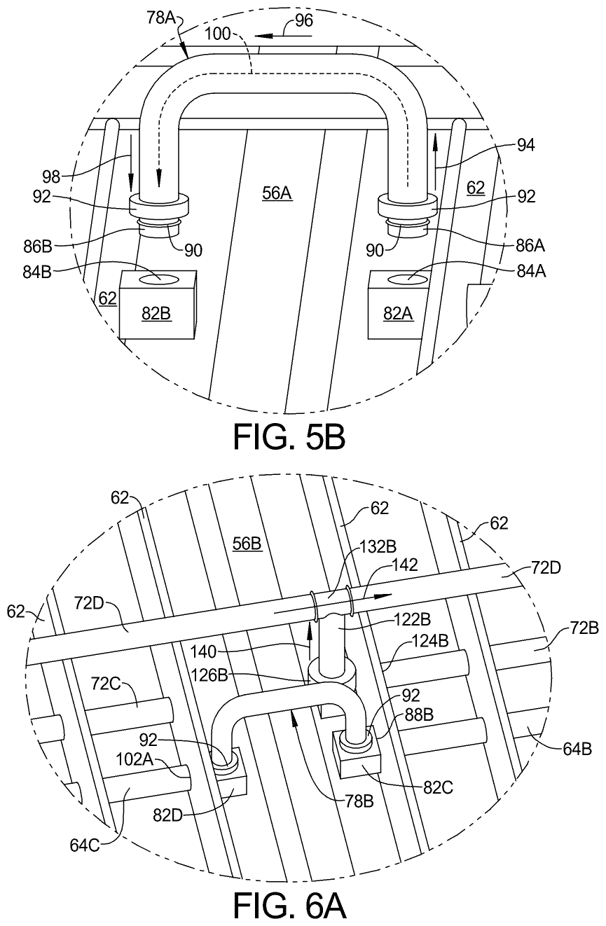

Referring to FIG. 5A and FIG. 5B, the first inlet flow channel segment 64A includes a second distal end 80B having a connection base 82A positioned thereon. The connection base 82A of the second distal end 80B of the first inlet flow channel 64A includes an upward facing orifice 84A adapted to receive a downward facing first distal end 86A of the first U-hose connector 78A. The second inlet flow channel segment 64B includes a first distal end 88A having a connection base 82B positioned thereon, the connection base 82B of the second inlet flow channel segment 64B including an upward facing orifice 84B adapted to receive a downward facing second distal end 86B of the first U-hose connector 78A. The first distal end 86A of the first U-hose connector 78A and the second distal end 86B of the first U-hose connector 78A each include an o-ring 90 adapted to create a fluid seal between the first U-hose connector 78A and the connection bases 82A, 82B.

Further, the first distal end 86A of the first U-hose connector 78A includes a hose fixture 92 mounted thereon and adapted to be secured to the connection base 82A of the first inlet flow channel segment 64A to secure the first distal end 86A of the first U-hose connector 78A within the orifice 84A of the connection base 82A of the first inlet flow channel segment 64A, and the second distal end 86B of the first U-hose connector 78A includes a hose fixture 92 mounted thereon and adapted to be secured to the connection base 82B of at the first distal end 88A of the second inlet flow channel segment 64B to secure the second distal end 86B of the first U-hose connector 78A within the orifice 84B of the connection base 82B of the second inlet flow channel segment 64B. In an exemplary embodiment, the hose fixtures 92 are secured to the connection bases 82A, 82B with a threaded fastener (not shown).

The first U-hose connector 78A has a shape extending upward from the connection base 82A of the first inlet flow channel segment 64A, as indicated by arrow 94, laterally over the first structural cross-member 56A of the battery pack 50, as indicated by arrow 96, and downward to the connection base 82B of the second inlet flow channel segment 64B, as indicated by arrow 98, defining a flow path 100 interconnecting the first inlet flow channel segment 64A to the second inlet flow channel segment 64B.

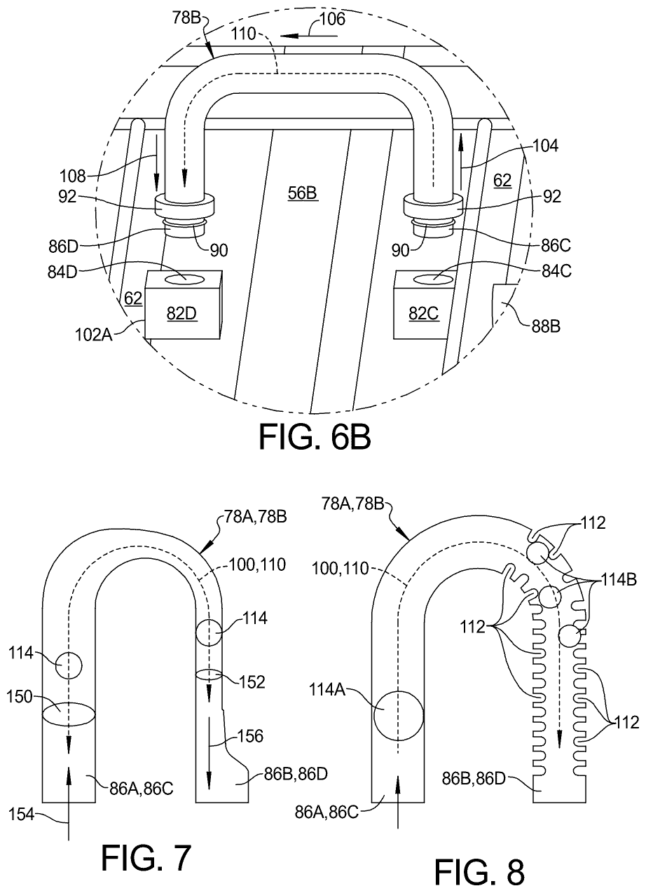

Referring to FIG. 6A and FIG. 6B, the second inlet flow channel segment 64B includes a second distal end 88B having a connection base 82C positioned thereon. The connection base 82C of the second distal end 88B of the second inlet flow channel 64B includes an upward facing orifice 84C adapted to receive a downward facing first distal end 86C of the second U-hose connector 78B. The third inlet flow channel segment 64C includes a first distal end 102A having a connection base 82D positioned thereon, the connection base 82D of the first distal end 102A of the third inlet flow channel segment 64C including an upward facing orifice 84D adapted to receive a downward facing second distal end 86D of the second U-hose connector 78B. The first distal end 86C of the second U-hose connector 78B and the second distal end 86D of the second U-hose connector 78B each include an o-ring 90 adapted to create a fluid seal between the second U-hose connector 78B and the connection bases 82C, 82D.

Further, the first distal end 86C of the second U-hose connector 78B includes a hose fixture 92 mounted thereon and adapted to be secured to the connection base 82C of the second distal end 88B of the second inlet flow channel segment 64B to secure the first distal end 86C of the second U-hose connector 78B within the orifice 84C of the connection base 82C of the second distal end 88B of the second inlet flow channel segment 64B, and the second distal end 86D of the second U-hose connector 78B includes a hose fixture 92 mounted thereon and adapted to be secured to the connection base 82D at the first distal end 102A of the third inlet flow channel segment 64C to secure the second distal end 86D of the second U-hose connector 78B within the orifice 84D of the connection base 82D of the first distal end 102A of the third inlet flow channel segment 64C. In an exemplary embodiment, the hose fixtures 92 are secured to the connection bases 82C, 82D with a threaded fastener (not shown).

The second U-hose connector 78B has a shape extending upward from the connection base 82C at the second distal end 88B of the second inlet flow channel segment 64B, as indicated by arrow 104, laterally over the second structural cross-member 56B of the battery pack 50, as indicated by arrow 106, and downward to the connection base 82D at the first distal end 102A of the third inlet flow channel segment 64C, as indicated by arrow 108, defining a flow path 110 interconnecting the second inlet flow channel segment 64B to the third inlet flow channel segment 64C.

Referring to FIG. 7, in an exemplary embodiment, the flow path 100, 110 defined by the first and second U-hose connectors 78A, 78B has a cross-sectional area that decreases moving from the first distal ends 86A, 86C of the first and second U-hose connectors 78A, 78B to the second distal ends 86B, 86D of the first and second U-hose connectors 78A, 78B, wherein, a flow rate of coolant flowing from the first distal ends 86A, 86C to the second distal ends 86B, 86D within each of the first and second U-hose connectors 78A, 78B increases. Frictional drag within the flow paths 100, 110 may cause air bubbles 114 within the flow paths 100, 110 to become trapped within the first and second U-hose connectors 78A, 78B. Buoyancy of the air bubbles 114 further acts to resist movement of the air bubbles downward toward the second distal ends 86B, 86D of the first and second U-hose connectors 78A, 78B. By decreasing the cross-sectional area of the flow paths 100, 110, the velocity of the coolant flowing therein increases and pulls air bubbles 114 trapped therein through the first and second U-hose connectors 78A, 78B. As shown in FIG. 7, a cross-sectional area 150 of the flow path 100, 110 of each of the first and second U-hose connectors 78A, 78B near the first distal ends 86A, 86C is larger than a cross-sectional area 152 of the flow path 100, 110 of each of the first and second U-hose connectors 78A, 78B near the second distal ends 86B, 86D, and thus, a velocity of the coolant entering the first distal ends 86A, 86C of the first and second U-hose connectors 78A, 78B, as indicated by arrow 154 is slower than a velocity of the coolant flowing within the flow paths 100, 110 near the second distal ends 86B, 86D, as indicated by arrow 156.

Referring to FIG. 8, in another exemplary embodiment, the flow path 100, 110 defined by the first and second U-hose connectors 78A, 78B has features 112 extending into the flow path 100, 110 at a position closer to the second distal ends 86B, 86D of the first and second U-hose connectors 78A, 78B than the first distal ends 86A, 86C of the first and second U-hose connectors 78A, 78B. The features are positioned on the downward flow side of the first and second U-hose connectors 78A, 78B and extend into the flow path 100, 110 to cause turbulence within the flow of coolant, breaking up large air bubbles 114A within the flow of coolant, making it easier for the flow of coolant to flush the smaller air bubbles 114B through the first and second U-hose connectors 78A, 78B. Further, the features 112 decrease the cross-sectional area of the flow paths 100, 110, increasing the velocity of the flow of coolant through the flow paths 100, 110, and more efficiently pulling the smaller air bubbles 114B trapped therein through the first and second U-hose connectors 78A, 78B. The features 112 may be bumps or finger-like extensions, extending into the flow paths 100, 110, or they may be annular rings or ridges extending around an inner diameter of the first and second U-hose connectors 78A, 78B.

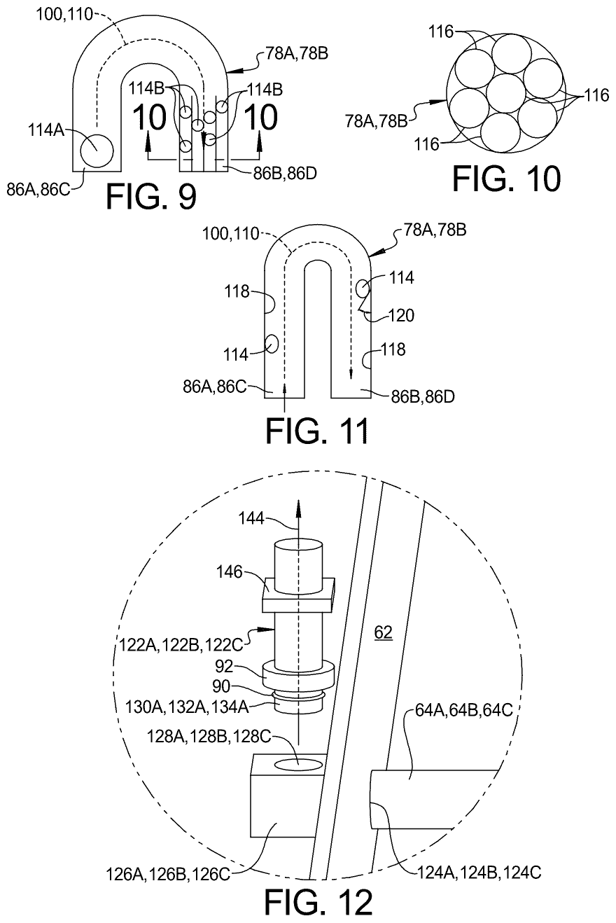

Referring to FIG. 9 and FIG. 10, each of the first and second U-hose connectors 78A, 78B includes a plurality of small tubes 116 positioned within the flow path 100, 110, parallel to the flow of coolant within the flow path 100, 110, adjacent the second distal ends 86B, 86D of the first and second U-hose connectors 78A, 78B. The tubes 116 are positioned on the downward flow side of the first and second U-hose connectors 78A, 78B and cause turbulence within the flow of coolant, breaking up large air bubbles 114A within the flow of coolant, making it easier for the flow of coolant to flush the smaller air bubbles 114B through the tubes 116 and through the first and second U-hose connectors 78A, 78B. Further, the tubes 116 decrease the cross-sectional area of the flow paths 100, 110, increasing the velocity of the flow of coolant through the flow paths 100, 110, and more efficiently pulling the smaller air bubbles 114B trapped therein through the first and second U-hose connectors 78A, 78B. As shown, the plurality of tubes 116 includes seven tubes 116 stacked within the flow paths 100, 110 of the first and second U-hose connectors 78A, 78B. It should be understood by those skilled in the art that the plurality of tubes 116 could include a higher number of tubes 116 having even smaller size. Further, the plurality of tubes 116 could include tubes of different sizes.

In still another exemplary embodiment, referring to FIG. 11, each of the first and second U-hose connectors 78A, 78B includes an inner surface 118 having a coating thereon that is adapted to reduce friction of the inner surface 118. Lower friction of the inner surface 118 of the first and second U-hose connectors 78A, 78B reduces the amount of frictional drag of air bubbles 114 passing over the inner surface 118. The reduced frictional drag reduces a contact angle 120 between the bubbles and the inner surface 118 of the first and second U-hose connectors 78A, 78B, making it easier for the flow of coolant through the flow paths 100, 110 to flush the air bubbles 114 through the first and second U-hose connectors 78A, 78B.

It should be understood by those skilled in the art that the cooling system 52 of the present disclosure can be practiced with one or more or any combination of decreasing cross-sectional area of the flow path 100, 110 within each of the first and second U-hose connectors 78A, 78B, features 112 extending into the flow path 100, 110 defined by each of the first and second U-hose connectors 78A, 78B, a plurality of small tubes 116 positioned within the flow path 100, 110 of each of the first and second U-hose connectors 78A, 78B, and a coating adapted to reduce the friction of the inner surface 118 of each of the first and second U-hose connectors 78A, 78B.

In an exemplary embodiment, the exit flow channel 72 comprises a plurality of exit flow channel segments 72A, 72B, 72C and a main exit channel 72D. A first exit flow channel segment 72A is in fluid communication with the thermal cooling channels 62 of the first module 76A, a second exit flow channel segment 72B is in fluid communication with the thermal cooling channels 62 of the second module 76B, and a third exit flow channel segment 72C is in fluid communication with the thermal cooling channels 62 of the third module 76C. A first vertical connector 122A interconnects the first exit flow channel segment 72A and the main exit channel 72D, a second vertical connector 122B interconnects the second exit flow channel segment 72B to the main exit channel 72D, and a third vertical connector 122C interconnects the third exit flow channel segment 72C to the main exit channel 72D.

The main exit channel 72D extends laterally over the plurality of thermal cooling channels 62 and structural cross members 56A, 56B, 56C of the battery pack 50. Coolant flows from the plurality of thermal cooling channels 62 within the first module 76A into the first exit flow channel segment 72A and through the first vertical connector 122A to the main exit channel 72D and back to the source of coolant 68. Coolant flows from the plurality of thermal cooling channels 62 within the second module 76B into the second exit flow channel segment 72B and through the second vertical connector 122B to the main exit channel 72D and back to the source of coolant 68. Coolant flows from the plurality of thermal cooling channels 62 within the third module 76C into the second exit flow channel segment 72C and through the third vertical connector 122C to the main exit channel 72D and back to the source of coolant 68.

Referring to FIG. 5A and FIG. 12, the first exit flow channel segment 72A includes a distal end 124A having a connection base 126A positioned thereon and including an upward facing orifice 128A, wherein a downward facing first distal end 130A of the first vertical connector is received within the upward facing orifice 128A of the connection base 126A at the distal end 124A of the first exit flow channel segment 72A. The first distal end 130A of the first vertical connector 122A includes an o-ring 90 adapted to create a fluid seal between the first vertical connector 122A and the connection base 126A at the distal end 124A of the first exit flow channel segment 72A.

Further, the first distal end 130A of the first vertical connector 122A includes a hose fixture 92 mounted thereon and adapted to be secured to the connection base 126A of the distal end 124A of the first exit flow channel segment 72A to secure the first distal end 130A of the first vertical connector 122A within the orifice 128A of the connection base 126A at the distal end 124A of the first exit flow channel segment 72A. In an exemplary embodiment, the hose fixture 92 is secured to the connection base 126A with a threaded fastener (not shown).

Referring to FIG. 6A and FIG. 12, the second exit flow channel segment 72B includes a distal end 124B having a connection base 126B positioned thereon and including an upward facing orifice 128B, wherein a downward facing first distal end 132A of the second vertical connector 122B is received within the upward facing orifice 128B of the connection base 126B at the distal end 124B of the second exit flow channel segment 72B. The first distal end 132A of the second vertical connector 122B includes an o-ring 90 adapted to create a fluid seal between the second vertical connector 122B and the connection base 126B at the distal end 124B of the second exit flow channel segment 72B.

Further, the first distal end 132A of the second vertical connector 122B includes a hose fixture 92 mounted thereon and adapted to be secured to the connection base 126B of the distal end 124B of the second exit flow channel segment 72B to secure the first distal end 132A of the second vertical connector 122B within the orifice 128B of the connection base 126B at the distal end 124B of the second exit flow channel segment 72B. In an exemplary embodiment, the hose fixture 92 is secured to the connection base 126B with a threaded fastener (not shown).

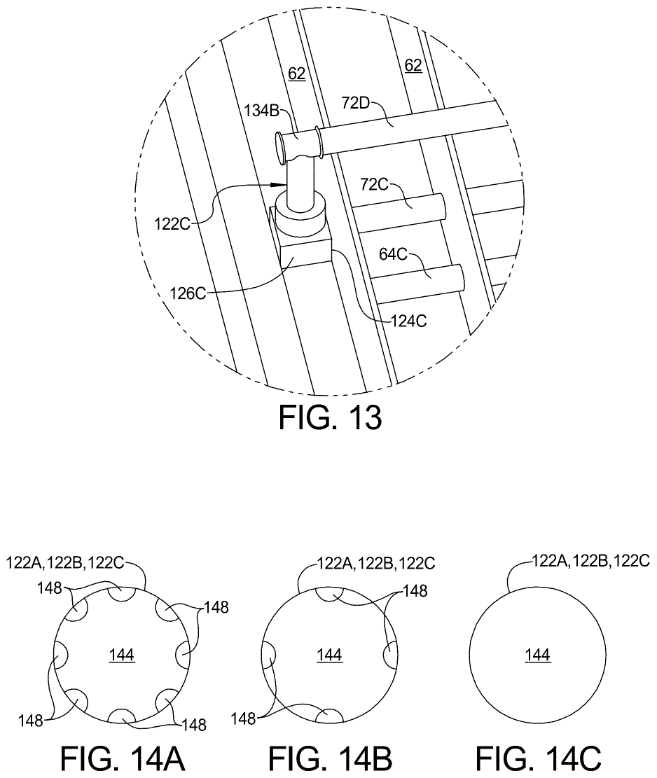

Referring to FIG. 12 and FIG. 13, the third exit flow channel segment 72C includes a distal end 124C having a connection base 126C positioned thereon and including an upward facing orifice 128C, wherein a downward facing first distal end 134A of the third vertical connector 122C is received within the upward facing orifice 128C of the connection base 126C at the distal end 124C of the third exit flow channel segment 72C. The first distal end 134A of the third vertical connector 122C includes an o-ring 90 adapted to create a fluid seal between the third vertical connector 122C and the connection base 126C at the distal end 124C of the third exit flow channel segment 72C.

Further, the first distal end 134A of the third vertical connector 122C includes a hose fixture 92 mounted thereon and adapted to be secured to the connection base 126C of the distal end 124C of the third exit flow channel segment 72C to secure the first distal end 134A of the third vertical connector 122C within the orifice 128C of the connection base 126C at the distal end 124C of the third exit flow channel segment 72C. In an exemplary embodiment, the hose fixture 92 is secured to the connection base 126C with a threaded fastener (not shown).

Referring again to FIG. 5A, a second distal end 130B of the first vertical connector 122A is in fluid communication with the main exit channel 72D via a T-connection, wherein coolant flows through the second distal end 130B of the first vertical connector 122A from the first exit flow channel segment 72A, as indicated by arrow 136, and from the second and third exit flow channels 122B, 122C, as indicated by arrow 138. Referring again to FIG. 6A, a second distal end 132B of the second vertical connector 122B is in fluid communication with the main exit channel 72D via a T-connection, wherein coolant flows through the second distal end 132B of the second vertical connector 122B from the second exit flow channel segment 72B, as indicated by arrow 140, and from the third exit flow channel 122C, as indicated by arrow 142. Referring again to FIG. 13, a second distal end 134B of the third vertical connector 122C is in fluid communication with the main exit channel 72D via an L-connection, wherein coolant flows through the second distal end 134B of the third vertical connector 122C from the third exit flow channel segment 72C, as indicated by arrow 144.

In an exemplary embodiment, referring again to FIG. 12, for each of the first, second and third exit flow channels 72A, 72B, 72C, the vertical connector 122A, 122B, 122C defines a flow path 144 from the connection base 126A, 126B, 126C of the exit flow channel segment 72A, 72B, 72C to the main exit channel 72D, and a cross-sectional area of the flow path 144 of the vertical connectors 122A, 122B, 122C is individually calibrated such that a pressure drop across each vertical connector 122A, 122B, 122C between the exit flow channel segment 72A, 72B, 72C and the main exit channel 72D is the same. This ensures a balanced flow of coolant through each module 76A, 76B, 76C of the cooling system 52 and even cooling of the battery pack 50.

In an exemplary embodiment, vertical connector 122A, 122B, 122C of each of the plurality of exit flow channel segments 72A, 72B, 72C includes a selectively variable valve 146, wherein the cross-sectional area (effective diameter of a circular flow path) of the flow path 144 of the vertical connector 122A, 122B, 122C is selectively and independently variable. In simplest terms, generally the cross-sectional area of the flow path of the first vertical connector 122A is smaller than the cross-sectional area of the flow path of the second vertical connector 122B, which is smaller than the cross-sectional area of the flow path of the third vertical connector 122C, due to the respective distances of each of the first, second and third vertical connectors 122A, 122B, 122C from the inlet port 66. The selectively variable valve 146 within each vertical connector 122A, 122B, 122C allows the cooling system 52 to maintain a balanced flow from all the modules 76A, 76B, 76C under variable conditions.

In another exemplary embodiment, for each of the first, second and third exit flow channel segments 72A, 72B, 72C, a fixed cross-sectional area of the flow path of the vertical connector 122A, 122B, 122C is individually calibrated based on an empirical correlation of the cross-sectional area of the vertical connectors 122A, 122B, 122C and a distance of the vertical connector 122A, 122B, 122C from the inlet port 66. In an exemplary embodiment, the Darcy-Weisbach equation can be used to design the first, second and third vertical connectors 122A, 122B, 122C taking into consideration aspects of the cooling system 52 such as density of the coolant, volumetric flow rates, and respective distances of each of the first, second and third vertical connectors 122A, 122B, 122C from the inlet port 66.

In another exemplary embodiment, for each of the first, second and third exit flow channel segments 72A, 72B, 72C, the vertical connector 122A, 122B, 122C defines a flow path from the connection base 126A, 126B, 126C of the exit flow channel segment 72A, 72B, 72C to the main exit channel 72D, wherein the flow path includes turbulator features 148 adapted to increase turbulence within the flow of coolant through the flow path. A density of the turbulator features 148 within the flow path of the vertical connector 122A, 122B, 122C is individually calibrated such that a pressure drop across each of the vertical connectors 122A, 122B, 122C varies respectively to balance the coolant flow.

For example, as discussed above, in simplest terms, generally the cross-sectional area of the flow path of the first vertical connector 122A is smaller than the cross-sectional area of the flow path of the second vertical connector 122B, which is smaller than the cross-sectional area of the flow path of the third vertical connector 122C, due to the respective distances of each of the first, second and third vertical connectors 122A, 122B, 122C from the inlet port 66. The flow of coolant through the first vertical connector 122A must be “throttled” more than the flow of coolant through the second vertical connector 122B because the first vertical connector 122A is closer to the inlet port 66. The flow of coolant through the second vertical connector 122B must be “throttled” more than the flow of coolant through the third vertical connector 122C because the second vertical connector 122A is closer to the inlet port 66. For example, the first vertical connector includes a higher density of turbulator features 148, as shown in FIG. 14A, than the second vertical connector, as shown in FIG. 14B. Correspondingly, the second vertical connector, as shown in FIG. 14B, includes a higher density of turbulator features 148 than the third vertical connector 122C, as shown in FIG. 14C. As shown, the third vertical connector 122C includes very few, or no turbulator features 148, due to its'distance from the inlet port 66 being the longest. The second and first vertical connectors 122B, 122A include a calibrated density of turbulator features 148 to ensure the pressure drop across each of the first, second and third vertical connectors 122A, 122B, 122C is the same.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A cooling system for a rechargeable battery pack, comprising:
a plurality of thermal cooling channels adapted to be positioned between adjacent rows of individual battery cells of the battery pack;
an inlet flow channel in fluid communication with each one of the plurality of thermal cooling channels and adapted to connect to a supply of coolant and provide a flow path between the supply of coolant and each one of the plurality of thermal cooling channels; and
an exit flow channel in fluid communication with each one of the plurality of thermal cooling channels and adapted to provide a flow path for coolant to exit each one of the plurality of thermal cooling channels;
the inlet flow channel including at least one U-hose connector adapted to route the inlet flow channel around a structural cross member of the battery pack.

2. The cooling system of claim 1, wherein the inlet flow channel comprises a plurality of inlet flow channel segments, and wherein:
a first inlet flow channel segment includes a distal end having a connection base positioned thereon, the connection base of the distal end of the first inlet flow channel including an upward facing orifice adapted to receive a downward facing first distal end of the at least one U-hose connector; and
a second inlet flow channel segment includes a distal end having a connection base positioned thereon, the connection base of the second inlet flow channel including an upward facing orifice adapted to receive a downward facing second distal end of the at least one U-hose connector; and
the at least one U-hose connector having a shape extending upward from the connection base of the first inlet flow channel segment, laterally over a structural cross member of the battery pack and downward to the connection base of the second inlet flow channel segment, defining a flow path interconnecting the first inlet flow channel segment to the second inlet flow channel segment.

3. The cooling system of claim 2, wherein:
the first distal end of the at least one U-hose connector includes a hose fixture mounted thereon and adapted to be secured to the connection base of the first inlet flow channel segment to secure the first distal end of the at least one U-hose connector within the orifice of the connection base of the first inlet flow channel segment; and
the second distal end of the at least one U-hose connector includes a hose fixture mounted thereon and adapted to be secured to the connection base of the second inlet flow channel segment to secure the second distal end of the at least one U-hose connector within the orifice of the connection base of the second inlet flow channel segment.

4. The cooling system of claim 3, wherein the flow path defined by the at least one U-hose connector has a cross-sectional area that decreases moving from the first distal end of the at least one U-hose connector to the second distal end of the at least one U-hose connector, wherein, a flow rate of coolant flowing from the first distal end to the second distal end increases.

5. The cooling system of claim 3, wherein the flow path defined by the at least one U-hose connector includes features extending into the flow path at a position closer to the second distal end of the at least one U-hose connector than the first distal end of the U-hose connector, the features adapted to decrease the cross-sectional area of the flow path and to break up air bubbles within the flow of coolant.

6. The cooling system of claim 3, wherein the at least one U-hose connector includes a plurality of small tubes positioned within the flow path, parallel to the flow of coolant within the flow path, adjacent the second distal end of the at least one U-hose connector, the tubes adapted to decrease the cross-sectional area of the flow path and break up air bubbles within the flow of coolant.

7. The cooling system of claim 3, wherein the flow path defined by the at least one U-hose connector includes an inner surface having a coating thereon adapted to reduce friction of the inner surface.

8. The cooling system of claim 3, wherein the flow path defined by the at least one U-hose connector includes at least one of:
a cross-sectional area that decreases moving from the first distal end of the at least one U-hose connector to the second distal end of the at least one U-hose connector;
features extending into the flow path at a position closer to the second distal end of the at least one U-hose connector than the first distal end of the U-hose connector, the features adapted to decrease the cross-sectional area of the flow path and to break up air bubbles within the flow of coolant;
a plurality of small tubes positioned therein, parallel to the flow of coolant within the flow path, adjacent the second distal end of the at least one U-hose connector, the tubes adapted to decrease the cross-sectional area of the flow path and break up air bubbles within the flow of coolant; and
an inner surface having a coating thereon adapted to reduce friction of the inner surface.

9. The cooling system of claim 3, wherein the exit flow channel comprises a plurality of exit flow channel segments and a main exit channel, and wherein:
each exit flow channel segment includes a distal end having a connection base positioned thereon and a vertical connector, the connection base including an upward facing orifice, wherein a downward facing first distal end of the vertical connector is received within the upward facing orifice of the connection base;
the main exit channel extending laterally over the plurality of thermal cooling channels and structural cross members of the battery pack and in fluid communication with second distal ends of the vertical connector of each of the plurality of exit flow channel segments; and
wherein, coolant flows from the plurality of thermal cooling channels into the plurality of exit flow channel segments and through the vertical connectors of the plurality of exit flow channel segments upward to the main exit channel.

10. The cooling system of claim 9, wherein, for each of the plurality of exit flow channel segments:
the first distal end of the vertical connector of the exit flow channel segment includes a hose fixture mounted thereon and adapted to be secured to the connection base of the exit flow channel segment to secure the first distal end of the vertical connector within the orifice of the connection base of the exit flow channel segment; and
the second distal end of the vertical connector defines one of a T-connection or an L-connection to the main exit channel.

11. The cooling system of claim 10, wherein, for each of the plurality of exit flow channel segments:
the vertical connector defines a flow path from the connection base of the exit flow channel segment to the main exit channel; and
a cross-sectional area of the flow path of the vertical connector is individually calibrated such that a total pressure drop across the vertical connector between the exit flow channel segment and the main exit channel is the same for each of the plurality of exit flow channel segments.

12. The cooling system of claim 11, wherein the vertical connector of each of the plurality of exit flow channel segments includes a selectively variable valve, wherein the cross-sectional area of the flow path of the vertical connector is selectively and independently variable.

13. The cooling system of claim 11, wherein, for each of the plurality of exit flow channel segments, the cross-sectional area of the flow path of the vertical connector is individually calibrated based on an empirical correlation of the cross-sectional area of the vertical connectors for each of the exit flow channel segments and a distance of the vertical connector from an inlet port and exit port, wherein the inlet port is adapted to connect the inlet flow channel to an external source of coolant and the exit port is adapted to connect the exit flow channel to the external source of coolant.

14. The cooling system of claim 10, wherein, for each of the plurality of exit flow channel segments:
the vertical connector defines a flow path from the connection base of the exit flow channel segment to the main exit channel;
the flow path including turbulator features adapted to increase turbulence within the flow of coolant through the flow path; and
a density of the turbulator features within the flow path of the vertical connector is individually calibrated such that a pressure drop across the vertical connector between the exit flow channel segment and the main exit channel is the same for each of the plurality of exit flow channel segments.

15. A rechargeable battery pack, comprising:
a plurality of battery cells; and
a cooling system for cooling the battery cells, the cooling system including:
a plurality of thermal cooling channels adapted to be positioned between adjacent rows of individual battery cells of the battery pack;
an inlet flow channel in fluid communication with each one of the plurality of thermal cooling channels and adapted to connect to a supply of coolant and provide a flow path between the supply of coolant and each one of the plurality of thermal cooling channels; and
an exit flow channel in fluid communication with each one of the plurality of thermal cooling channels and adapted to provide a flow path for coolant to exit each one of the plurality of thermal cooling channels;
the inlet flow channel including a plurality of inlet flow channel segments and at least one U-hose connector adapted to route the inlet flow channel around a structural cross member of the battery pack, wherein:
a first inlet flow channel segment includes a distal end having a connection base positioned thereon, the connection base of the distal end of the first inlet flow channel including an upward facing orifice adapted to receive a downward facing first distal end of the at least one U-hose connector, and the first distal end of the at least one U-hose connector includes a hose fixture mounted thereon and adapted to be secured to the connection base of the first inlet flow channel segment to secure the first distal end of the at least one U-hose connector within the orifice of the connection base of the first inlet flow channel segment; and
a second inlet flow channel segment includes a distal end having a connection base positioned thereon, the connection base of the second inlet flow channel including an upward facing orifice adapted to receive a downward facing second distal end of the at least one U-hose connector, and the second distal end of the at least one U-hose connector includes a hose fixture mounted thereon and adapted to be secured to the connection base of the second inlet flow channel segment to secure the second distal end of the at least one U-hose connector within the orifice of the connection base of the second inlet flow channel segment; and
the at least one U-hose connector having a shape extending upward from the connection base of the first inlet flow channel segment, laterally over a structural cross member of the battery pack and downward to the connection base of the second inlet flow channel segment, defining a flow path interconnecting the first inlet flow channel to the second inlet flow channel.

16. The rechargeable battery pack of claim 15, wherein the flow path defined by the at least one U-hose connector includes at least one of:
a cross-sectional area that decreases moving from the first distal end of the at least one U-hose connector to the second distal end of the at least one U-hose connector, wherein, a flow rate of coolant flowing from the first distal end to the second distal end increases;
features extending into the flow path at a position closer to the second distal end of the at least one U-hose connector than the first distal end of the U-hose connector, the features adapted to decrease the cross-sectional area of the flow path and to break up air bubbles within the flow of coolant;
a plurality of small tubes positioned within the flow path, parallel to the flow of coolant within the flow path, adjacent the second distal end of the at least one U-hose connector, the tubes adapted to decrease the cross-sectional area of the flow path and break up air bubbles within the flow of coolant; and
an inner surface having a coating thereon adapted to reduce friction of the inner surface.

17. The rechargeable battery pack of claim 16, wherein the exit flow channel comprises a plurality of exit flow channel segments and a main exit channel, and wherein:
each exit flow channel segment includes a distal end having a connection base positioned thereon and a vertical connector, the connection base including an upward facing orifice, wherein a downward facing first distal end of the vertical connector is received within the upward facing orifice of the connection base, the main exit channel extending laterally over the plurality of thermal cooling channels and structural cross members of the battery pack and in fluid communication with second distal ends of the vertical connector of each of the plurality of exit flow channel segments, and, wherein, coolant flows from the plurality of thermal cooling channels into the plurality of exit flow channel segments and through the vertical connectors of the plurality of exit flow channel segments upward to the main exit channel;
for or each of the plurality of exit flow channel segments:
the first distal end of the vertical connector of the exit flow channel segment includes a hose fixture mounted thereon and adapted to be secured to the connection base of the exit flow channel segment to secure the first distal end of the vertical connector within the orifice of the connection base of the exit flow channel segment;
the second distal end of the vertical connector defines one of a T-connection or an L-connection to the main exit channel;
the vertical connector defines a flow path from the connection base of the exit flow channel segment to the main exit channel; and
a cross-sectional area of the flow path of the vertical connector is individually calibrated such that a pressure drop across the vertical connector between the exit flow channel segment and the main exit channel is the same for each of the plurality of exit flow channel segments.

18. The rechargeable battery pack of claim 17, wherein, for each of the plurality of exit flow channel segments, at least one of:
the vertical connector includes a selectively variable valve, wherein the cross-sectional area of the flow path of the vertical connector is selectively and independently variable;
the cross-sectional area of the flow path of the vertical connector is individually calibrated based on an empirical correlation of the cross-sectional area of the vertical connectors for each of the exit flow channel segments and a distance of the vertical connector from an inlet port and exit port, wherein the inlet port is adapted to connect the inlet flow channel to an external source of coolant and the exit port is adapted to connect the exit flow channel to the external source of coolant; and
the flow path of the vertical connector includes turbulator features adapted to increase turbulence within the flow of coolant through the flow path, and a density of the turbulator features within the flow path of the vertical connector is individually calibrated such that a pressure drop across the vertical connector between the exit flow channel segment and the main exit channel is the same for each of the plurality of exit flow channel segments.

19. An electric vehicle having a rechargeable battery pack, comprising:
a plurality of battery cells; and
a cooling system for cooling the battery cells, the cooling system including:
a plurality of thermal cooling channels adapted to be positioned between adjacent rows of individual battery cells of the battery pack;
an inlet flow channel in fluid communication with each one of the plurality of thermal cooling channels and adapted to connect to a supply of coolant and provide a flow path between the supply of coolant and each one of the plurality of thermal cooling channels; and
an exit flow channel in fluid communication with each one of the plurality of thermal cooling channels and adapted to provide a flow path for coolant to exit each one of the plurality of thermal cooling channels;
the inlet flow channel including a plurality of inlet flow channel segments and at least one U-hose connector adapted to route the inlet flow channel around a structural cross member of the battery pack, wherein:
a first inlet flow channel segment includes a distal end having a connection base positioned thereon, the connection base of the distal end of the first inlet flow channel including an upward facing orifice adapted to receive a downward facing first distal end of the at least one U-hose connector, and the first distal end of the at least one U-hose connector includes a hose fixture mounted thereon and adapted to be secured to the connection base of the first inlet flow channel segment to secure the first distal end of the at least one U-hose connector within the orifice of the connection base of the first inlet flow channel segment; and
a second inlet flow channel segment includes a distal end having a connection base positioned thereon, the connection base of the second inlet flow channel including an upward facing orifice adapted to receive a downward facing second distal end of the at least one U-hose connector, and the second distal end of the at least one U-hose connector includes a hose fixture mounted thereon and adapted to be secured to the connection base of the second inlet flow channel segment to secure the second distal end of the at least one U-hose connector within the orifice of the connection base of the second inlet flow channel segment; and
the at least one U-hose connector having a shape extending upward from the connection base of the first inlet flow channel segment, laterally over a structural cross member of the battery pack and downward to the connection base of the second inlet flow channel segment, defining a flow path interconnecting the first inlet flow channel to the second inlet flow channel; and
wherein the flow path defined by the at least one U-hose connector includes at least one of:
a cross-sectional area that decreases moving from the first distal end of the at least one U-hose connector to the second distal end of the at least one U-hose connector, wherein, a flow rate of coolant flowing from the first distal end to the second distal end increases;
features extending into the flow path at a position closer to the second distal end of the at least one U-hose connector than the first distal end of the U-hose connector, the features adapted to decrease the cross-sectional area of the flow path and to break up air bubbles within the flow of coolant;
a plurality of small tubes positioned within the flow path, parallel to the flow of coolant within the flow path, adjacent the second distal end of the at least one U-hose connector, the tubes adapted to decrease the cross-sectional area of the flow path and break up air bubbles within the flow of coolant; and
an inner surface having a coating thereon adapted to reduce friction of the inner surface.

20. The electric vehicle of claim 19, wherein the exit flow channel comprises a plurality of exit flow channel segments and a main exit channel, and wherein:
each exit flow channel segment includes a distal end having a connection base positioned thereon and a vertical connector, the connection base including an upward facing orifice, wherein a downward facing first distal end of the vertical connector is received within the upward facing orifice of the connection base, the main exit channel extending laterally over the plurality of thermal cooling channels and structural cross members of the battery pack and in fluid communication with second distal ends of the vertical connector of each of the plurality of exit flow channel segments, and, wherein, coolant flows from the plurality of thermal cooling channels into the plurality of exit flow channel segments and through the vertical connectors of the plurality of exit flow channel segments upward to the main exit channel;
for or each of the plurality of exit flow channel segments:
the first distal end of the vertical connector of the exit flow channel segment includes a hose fixture mounted thereon and adapted to be secured to the connection base of the exit flow channel segment to secure the first distal end of the vertical connector within the orifice of the connection base of the exit flow channel segment;
the second distal end of the vertical connector defines one of a T-connection or an L-connection to the main exit channel;
the vertical connector defines a flow path from the connection base of the exit flow channel segment to the main exit channel; and
a cross-sectional area of the flow path of the vertical connector is individually calibrated such that a total pressure drop across the vertical connector between the exit flow channel segment and the main exit channel is the same for each of the plurality of exit flow channel segments, and at least one of:
the vertical connector includes a selectively variable valve, wherein the cross-sectional area of the flow path of the vertical connector is selectively and independently variable;
the cross-sectional area of the flow path of the vertical connector is individually calibrated based on an empirical correlation of the cross-sectional area of the vertical connectors for each of the exit flow channel segments and a distance of the vertical connector from an inlet port and exit port, wherein the inlet port is adapted to connect the inlet flow channel to an external source of coolant and the exit port is adapted to connect the exit flow channel to the external source of coolant; and
the flow path of the vertical connector includes turbulator features adapted to increase turbulence within the flow of coolant through the flow path, and a density of the turbulator features within the flow path of the vertical connector is individually calibrated such that a pressure drop across the vertical connector between the exit flow channel segment and the main exit channel is the same for each of the plurality of exit flow channel segments.
